(19) United States
(12) Patent Application Publication
(10) Pub. No.: US 2026/0272097 A1
(43) Pub. Date: Sep. 17, 2026

(54) THREE-DIMENSIONAL PRINTED BUFFER STRUCTURE FOR HELMETS

(71) Applicant: Amplifi Tech (Xiamen) Limited, Xiamen (CN)

(72) Inventor: Tsung-Han LEE, Taoyuan City (TW)

(21) Appl. No.: 19/561,665

(22) Filed: Mar. 10, 2026

(30) Foreign Application Priority Data
Mar. 14, 2025 (CN) 202510305009.1

(51) Int. Cl. A42B 3/12; B33Y 80/00

(52) U.S. Cl. CPC A42B 3/12; B33Y 80/00

(57) ABSTRACT

A three-dimensional printed buffer structure for helmets includes a first buffer layer. The first buffer layer includes an outer surface portion, an inner surface portion, and supporting parts. The outer surface portion includes first rods arranged to intersect and form a grid, with the first rods defining an outer contour near a helmet shell. The inner surface portion includes second rods that extend continuously and are spaced apart, remaining adjacent to one another without intersecting, with the second rods defining an inner contour close to a user. The supporting parts are arranged between the outer surface portion and the inner surface portion, with each of the supporting parts having a first end and a second end, in which the first end and the second end of any one of the supporting parts are respectively connected to any one of the first rods and any one of the second rods.

### CROSS-REFERENCE TO RELATED APPLICATION

This application claims priority to China Patent Application 202510305009.1, filed Mar. 14, 2025, which is incorporated herein by reference.

### FIELD OF DISCLOSURE

The present disclosure relates to a three-dimensional printed buffer structure, especially a three-dimensional printed buffer structure for helmets.

### DESCRIPTION OF RELATED ART

A common modern helmet design usually emphasizes absorbing the force applied in the vertical direction. However, the issue of how to reduce the lateral offset or rotation problems caused by the lateral force applied to the helmet has not been fully resolved. In actual use, when the helmet is subjected to a lateral force, a lateral offset or rotation between the helmet and the user's head may occur easily due to a deficiency in buffer structure design. Such a lateral offset or rotation not only may reduce the stability of the helmet, but also may cause localized stress concentration in certain areas, increasing the risk for user injuries. In addition, the design of the buffer structure of the existing helmets has a relatively limited stress-dispersive capability, leading to the problem of localized stress concentration. Therefore, how to effectively increase the stability of the helmet under the impact of lateral force, and at the same time, the stress-dispersion capability of the helmet, is what the technical personnel and researchers of the industry yearn to achieve.

### SUMMARY

According to several embodiments of the present disclosure, a three-dimensional printed buffer structure for helmets comprises a first buffer layer. The first buffer layer comprises an outer surface portion, an inner surface portion, and a plurality of supporting parts. The outer surface portion comprises a plurality of first rods, wherein the plurality of first rods are arranged to intersect and form a grid, with the plurality of first rods defining an outer contour closer to a helmet shell. The inner surface portion comprises a plurality of second rods that extend continuously and are spaced apart, remaining adjacent to one another without intersecting, with the plurality of second rods defining an inner contour close to a user. The plurality of supporting parts are disposed between the outer surface portion and the inner surface portion, with each of the plurality of supporting parts having a first end and a second end, wherein the first end and the second end of any one of the plurality of supporting parts are respectively connected to any one of the plurality of first rods and any one of the plurality of second rods. The plurality of first rods, the plurality of second rods, and the plurality of supporting parts are integrally formed by three-dimensional printing.

In several embodiments of the present disclosure, any one of the plurality of supporting parts is a column.

In several embodiments of the present disclosure, a first connection angle between any one of the plurality of supporting parts and the plurality of first rods that are connected thereto is 45 degrees to 135 degrees, and a second connection angle between any one of the plurality of supporting parts and the plurality of second rods that are connected thereto is 45 degrees to 135 degrees.

In several embodiments of the present disclosure, the first end of any one of the plurality of supporting parts is connected to one intersection point of the grid.

In several embodiments of the present disclosure, any two or more adjacent supporting parts of the plurality of supporting parts intersect with one another mutually.

In several embodiments of the present disclosure, any two or more of the adjacent supporting parts intersect mutually with any one of the plurality of first rods or any one of the plurality of second rods.

In several embodiments of the present disclosure, the three-dimensional printed buffer structure further comprises a second buffer layer, connected with the outer surface portion and disposed between the outer surface portion and the helmet shell, which comprises a plurality of lattice structure units, with each of the plurality of lattice structure units having a hollowed-out area.

In several embodiments of the present disclosure, the plurality of first rods, the plurality of second rods, the plurality of supporting parts, and the plurality of lattice structure units are integrally formed by three-dimensional printing.

In several embodiments of the present disclosure, each of the plurality of first rods, each of the plurality of second rods, and each of the plurality of supporting parts has a plurality of foam structures, respectively.

In several embodiments of the present disclosure, the plurality of first rods have a plurality of first hollowed-out areas thereamong; the plurality of second rods have a plurality of second hollowed-out areas thereamong; the plurality of supporting parts have a plurality of third hollowed-out areas thereamong; and the plurality of first hollowed-out areas, the plurality of second hollowed-out areas, and the plurality of third hollowed-out areas are connected.

According to the aforementioned embodiments of the present disclosure, the outer surface portion of the first buffer layer, composed of grids (the first rods) of a non-filled design, may disperse the external force toward a larger range that reduces damage to a single area under concentrated stress, effectively lowering the injury risk. The inner surface portion of the first buffer layer, composed of rods (second rods) extending continuously and spaced apart and remaining adjacent to one another without intersecting, can provide a well-fitting (conformity) effect and, with the design of the supporting parts, can increase the friction between the first buffer layer and the head of the user in a specific direction to further limit the relative displacement between the helmet and the head of the user, thus restricting the helmet in lateral offset or rotation and increase the wearing stability of a helmet. Furthermore, through the deflection effect of the supporting parts, the first rods and the second rods in the horizontal direction share the load exerted vertically and achieve the stress-dispersion effect. Overall, through the synergy of the first rods, the second rods, and the supporting parts, the present disclosure can increase the whole protective performance and wearing stability of a helmet through a method different from those of “directly absorbing the vertical stress.”

### BRIEF DESCRIPTION OF THE FIGURES

To better understand the aforementioned and other objectives, novel features, advantages, embodiments, and the effect of the present disclosure, figures are provided as follows:

FIG. 1 is a stereo schematic figure of the three-dimensional printed buffer structure for helmets according to several embodiments of the present disclosure;

FIG. 2 is a partial enlarged schematic figure of an area R1 of the three-dimensional printed buffer structure of FIG. 1;

FIG. 3 is a partial enlarged schematic figure of an area R2 of the three-dimensional printed buffer structure of FIG. 1 after adjusting the viewing angle;

FIG. 4A is a partial enlarged schematic figure of an area R3 of the three-dimensional printed buffer structure of FIG. 1 after adjusting the viewing angle;

FIG. 4B is a partial enlarged schematic figure of an area R4 of the three-dimensional printed buffer structure of FIG. 1 after adjusting the viewing angle;

FIG. 5A is a partial enlarged schematic figure of an area R5 of the three-dimensional printed buffer structure of FIG. 2;

FIG. 5B is a structural type of supporting parts according to several other embodiments of the present disclosure, with the illustrated area corresponding to the area R5 of the three-dimensional printed buffer structure of FIG. 2;

FIG. 6 is a schematic sectional micro-scale view of the first rod, the second rod, or the supporting part according to several embodiments of the present disclosure; and

FIGS. 7A to 7H are schematic figures of the lattice structures of lattice structure units according to different embodiments of the present disclosure.

### DETAILED DESCRIPTION

A plurality of embodiments of the present disclosure will be disclosed below with reference to the figures. For the purpose of clear illustration, many details in practice will be provided together with the following descriptions. However, these detailed descriptions in practice shall not be interpreted to limit the scope, applicability, or configuration of the present disclosure in any way. To make it easier for readers, the dimensions of every component in the drawing are not produced according to the actual scale. Furthermore, relative terms, such as "lower" and "upper", are used in this specification to describe relations of a component with another component. As illustrated in the figures, the purpose of relative terms is to cover components of different directions in addition to the direction that is illustrated. The terms “first” and “second” in the specification and claims are only used to specify different components or to distinguish different embodiments or ranges, and shall not be interpreted as the highest or lowest limit of the quantity of the component, or the manufacturing sequence, or the sequence of installing the components.

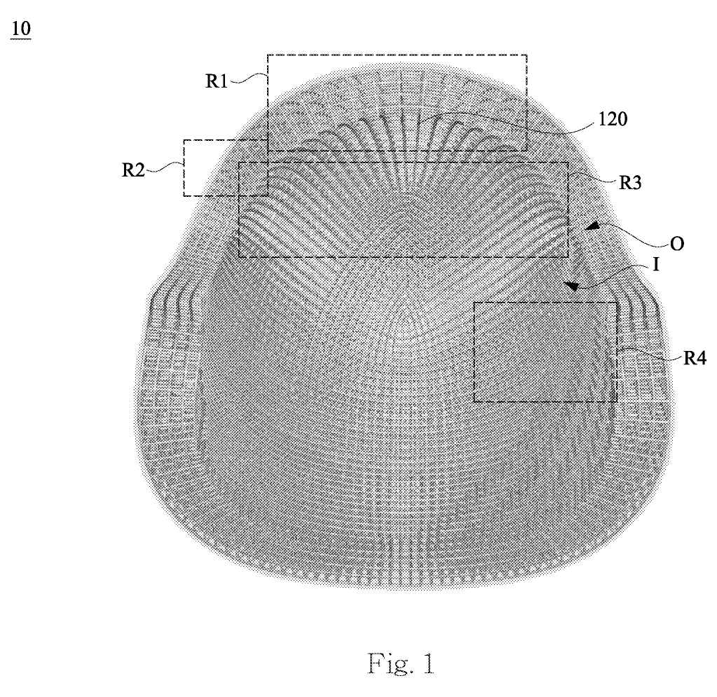

Please refer to FIG. 1, which is a stereo schematic figure of the three-dimensional printed buffer structure 10 for helmets according to several embodiments of the present disclosure, showing a viewing angle from the bottom opening of the helmet toward the internal structure thereof. Please note that the term “helmet” in the present disclosure refers to equipment for protecting the head in general that can be applied to various activities, including but not limited to daily routine, exercise, work, and military activities. The helmet can be a bike helmet, a ski helmet, a roller skate helmet, a rock climbing helmet, an equestrian helmet, a baseball catcher’s helmet, a hockey helmet, a hard hat (used in construction or industrial sites), a tactical helmet (used in military or tactical operations), a fire and rescue helmet, or a riot protection helmet (used in law enforcement or security operations). The three-dimensional printed buffer structure 10 of the current disclosure can, for example, be installed on the inner surface of the hard shell of the helmet (that is, the side of the helmet next to a head of the user) as an inner liner of the helmet, and can be directly in contact with the head of the user.

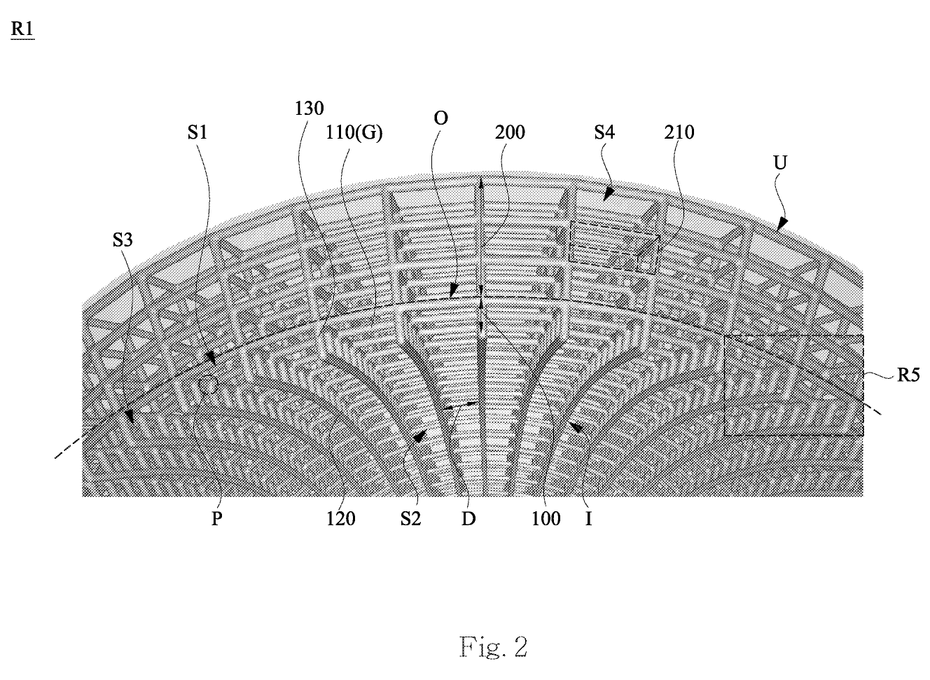

FIG. 2 is a partial enlarged schematic figure of an area R1 of the three-dimensional printed buffer structure 10 of FIG. 1. Please refer to FIG. 1 and FIG. 2 at the same time. The three-dimensional printed buffer structure 10 comprises a first buffer layer 100. The first buffer layer 100 comprises an outer surface portion O, an inner surface portion I, and a plurality of supporting parts 130. The outer surface portion O is relatively closer to the helmet shell. The inner surface portion I is relatively closer to the head of the user. The supporting parts 130 are disposed and connected between the outer surface portion O and the inner surface portion I.

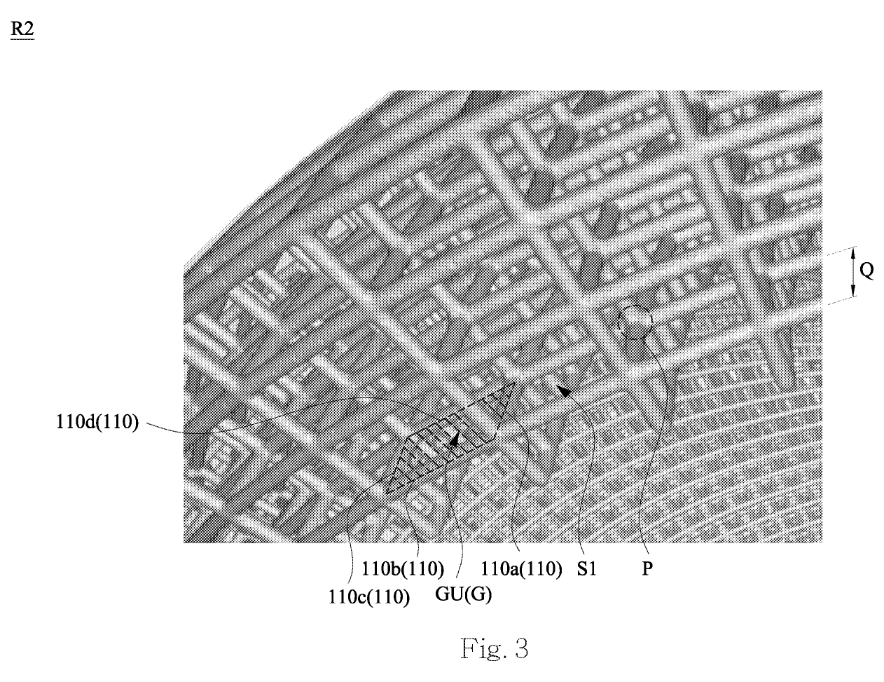

The outer surface portion O of the first buffer layer 100 comprises a plurality of first rods 110. The plurality of first rods 110 are arranged to intersect and form a grid G with a plurality of intersection points P, and define an outer contour near the helmet shell. In other words, the plurality of first rods 110 define a contour of the outer surface portion O of the first buffer layer 100. The geometric features of the grid G of the present disclosure appear to be a two-dimensional distribution type, and the entirety of the structure forms a continuous and complete two-dimensional grid structure. To better understand the structural type of the grid G, please refer to FIG. 3, which is a partial enlarged schematic figure of an area R2 of the three-dimensional printed buffer structure 10 of FIG. 1 after adjusting the viewing angle. As shown in FIG. 3, four first rods, 110a, 110b, 110c, and 110d, are disposed around to form a grid unit GU, and a plurality of grid units GU are connected closely on the same surface (for example, the surface marked as an arc-shaped curved surface Q in FIG. 3) to constitute a grid G of a complete integral two-dimensional grid structure. In comparison with a structure having a fully filled surface (a completely solid structure), the grid G formed by the first rods 110, which are arranged to intersect, has a relatively larger space for deformation under the action (impact) of external forces, where the grid G can disperse the stress uniformly through a high degree of freedom yet controllable deformation, and then reduce the damage to a single area caused by the concentrated stress. Furthermore, the grid G with a design of a non-fully filled structure can not only achieve a lightweight structure, but also provide outstanding air permeability and, therefore, offer wearing comfort at the same time.

On the other hand, a plurality of first rods 110, configured to intersect with one another, forms a plurality of hollowed-out areas S1 therebetween. The hollowed-out areas S1, surrounded and formed by the first rods 110, can not only reduce the structural rigidity, but also provide additional buffer spaces that allow the first rods 110 to flexibly form deformations in multiple directions while under the actions of external forces to enhance the effects of absorption and release of energy, leading to reduction in impact load to the head of the user. In several embodiments, the grid G can have various opening shapes (that is, the shapes of the hollowed-out areas S1) for example, but not limited to, triangle, quadrilateral (for example, parallelogram, rectangle, trapezoid, rhombus, irregular quadrilateral), hexagon (for example, honeycomb shape), or a combination thereof, to provide protection during different usage scenarios. This embodiment uses a rectangle as an example.

Please refer to FIG. 2 again. An inner surface portion I of the first buffer layer 100 comprises a plurality of second rods 120. The plurality of second rods 120 extend continuously and are spaced apart, remaining adjacent to one another without intersecting, with the second rods defining an inner contour close to the head of the user. In other words, the plurality of second rods 120 define a contour of the inner surface portion I of the first buffer layer 100. In several embodiments, the inner surface portion I may directly contact the head of the user. Through arranging a plurality of the second rods 120 extending continuously and spaced apart, remaining adjacent to one another without intersecting, such a design can not only provide the well-fitting (conformity) by adapting to the shape of the head of the user, but also distribute the stress uniformly in order to reduce pressure at certain local points, thus enhancing wearing comfort. On the other hand, two adjacent second rods 120 have a spacing area S2 therebetween. The spacing area S2 can help to increase the air permeability, so that the air flows in a specific direction between rods, resulting in the heat dissipation effect being improved and the sultriness being reduced when wearing a helmet.

In several embodiments, in order to adapt to different head shapes of the users, the second rods 120 can have different arrangement designs for different portions of a head, and can generally extend along a single direction within the same portion area. The following examples will be described along with FIG. 1 by dividing the head area into multiple portions. In the embodiment of FIG. 1, the second rods 120 corresponding to the front region of the head (at the upper position of FIG. 1) generally start from the frontal region (including the frontal region, side of the frontal region, and the temporal region) and extend to the top of the head. The second rods 120 corresponding to the middle region of the head (at the middle position of FIG. 1) generally start from the areas around the ears on both sides of the head and extend to the top of the head. The second rods 120 corresponding to the back region of the head (at the lower position of FIG. 1) generally start from the right (left) side of the head and extend laterally to the left (right) side of the head. Such a design can prevent the potential problems brought by an arrangement of the second rods 120 extending along the same direction within and across the entire first buffer layer 100. For example, if all second rods 120 within the entire first buffer layer 100 extend in the same direction from the frontal region to the back of the head (occiput), when an external force acts on the frontal region or the occiput, the helmet will be easily pushed along the extending direction of the second rods 120 of the first buffer layer 100, without the resistance from directions other than the extending direction of the second rods 120, leading to a relative displacement between the helmet and the head of the user, and the downgrading of the protection effect.

On the contrary, in several embodiments of the present disclosure, the second rods 120 are designed with different extending directions in different areas, so that the second rods 120 as a whole have a diversifying arrangement pattern, designed to maintain a stable and fixed position between the helmet and the head of the user, thus effectively dispersing and resisting external forces coming from various directions, and enhancing the overall protection of the helmet. In general, the design of the extending direction of the second rods 120 can effectively reduce the possibility of external forces transmitting along the axis perpendicular to the extending direction thereof. Meanwhile, for the external forces transmitting along the direction perpendicular to the extending direction of the second rods 120, the second rods 120 can provide steady friction due to the extending direction thereof being perpendicular to the external forces, which helps reduce or prevent the first buffer layer 100 from having a displacement in the direction perpendicular to the extending direction of the second rods 120, effectively suppressing the phenomena of sliding or offsetting, and thus further improving the structural stability and the protection effect on users.

It is worth mentioning that, although the second rods 120 may have different arrangement patterns in different portions, the second rods 120 can enable smooth connections between different portions, with these connections of the second rods 120 having a characteristic of overall continuity. With this, two pieces of second rods 120 can be integrated into one seamless and uniformly extended piece of second rod 120. In other words, two pieces of second rods 120 may be treated as one continuously extended piece of a second rod 120 after a smooth connection. Such a design of smooth connection can not only reduce the possibility of having stress concentrated at the connection that is not seamless, but also guide the external forces to spread out uniformly along the continuously extended second rods 120, thus reducing the risk of partial deformation or damage.

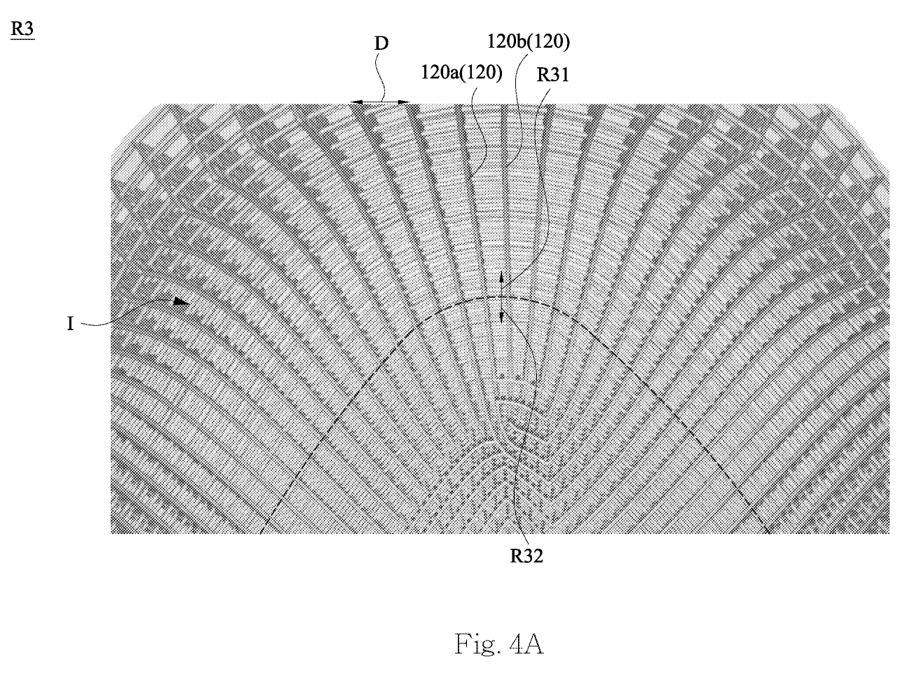

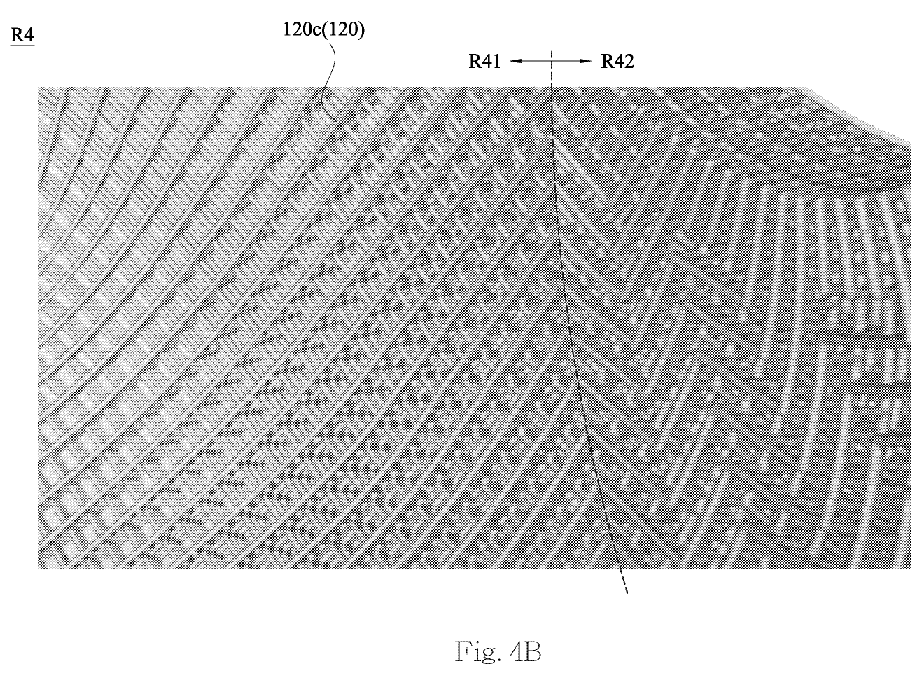

Please refer to FIG. 2 again. In several embodiments, the second rods 120 can also proportionately include curved or transactional designs in different portions according to the special geometric characteristics of the head of the user, and at the same time maintain a certain degree of spacing between them. Furthermore, the distance D between the second rods 120 may be adjusted according to the geometric characteristics of the head of the user. For example, for areas that need higher supporting forces, the distance D is reduced, or for areas that need larger buffer zones or evading spaces, the distance D is increased, so that the overall structure has decent support, buffering, and fitness (conformity). FIG. 4A and FIG. 4B are hereby presented as examples for further explanation. FIG. 4A is a partial enlarged schematic figure of an area R3 of the three-dimensional printed buffer structure 10 of FIG. 1 after adjusting the viewing angle. FIG. 4B is a partial enlarged schematic figure of an area R4 of the three-dimensional printed buffer structure 10 of FIG. 1 after adjusting the viewing angle.

FIG. 4A shows the distribution types of the second rods 120 of the first buffer layer 100 from the area R31 that corresponds to the position of the frontal region, to the area R32 that corresponds to the position of the top of the head, separated by a dashed line. Overall, the plurality of second rods 120 gradually converge from the area R31 that corresponds to the position of the forehead region, to the area R32 that corresponds to the position of the top of the head (that is, the distance D between the second rods 120 gradually reduces). In addition, the plurality of second rods 120 curves around proportionately according to the hair whorl pattern on the scalp in the area R32 that corresponds to the position of the top of the head. Furthermore, if the head curve needs to be fitted more flexibly, some of the second rods 120 may be further smoothly connected with other second rods 120 in the curved sections (regarded as a combined extension). For example, the second rod 120a shown in FIG. 4A in the area R31 that corresponds to the position of the frontal region, generally extends along the same direction, and curves around in the area R32 that corresponds to the position of the top of the head, and is further achieving smooth connection with the second rod 120b that also extends from the area R31 to the area R32 to form a single second rod 120 with a curved pattern. Such a design allows the second rod 120 to provide supporting forces uniformly and conformally along the natural curves of the hair whorl, and prevent the oppressive feeling in the hair whorl area of the head.

One should note that although some second rods 120 may achieve a smooth connection with other second rods 120 during the extending process, such a condition only occurs when the second rods 120 need to adapt to a relatively larger change in direction or at a structural transition point. In other words, the smooth connection between the second rods 120 only happens in the areas where adaptability in special geometric features is needed (for example, the area corresponding to the hair whorl area of the head described in FIG. 4). Overall, most of the second rods 120 in a single area of the first buffer layer 100 maintain a consistent extending direction, thus the second rods 120 can correspond to that area on a large scale while adapting to the head shape, and at the same time maintain the structural consistency of the inner surface portion I of the first buffer layer 100, thus providing supporting forces uniformly.

FIG. 4B shows the distribution types of the second rods 120 of the first buffer layer 100 from the area R41, corresponding to the position of the back of the head, to the area R42, corresponding to the position of the ears, separated by a dashed line. Overall, the plurality of second rods 120 continuously extend from the area R41, corresponding to the position of the back of the head, to the area R42, corresponding to the position of the ears. In the area R42, corresponding to the position of ears, the plurality of second rods 120 may have curve designs according to the shape of the ear contour to prevent the oppressive feeling and sultriness. For example, the second rod 120c in the area R41, corresponding to the position of the back of the head shown in FIG. 4B, generally extends along the same direction, and makes a turn in a lightning bolt style once it enters the area R42 to correspond with the position of the ear, and then continuously extends onwards. Meanwhile, the distance between two adjacent second rods 120 extending from the area R41, corresponding to the position of the back of the head, to the area R42, corresponding to the position of the ear, remains essentially constant. The shape of a lightning bolt style may flexibly adapt to the complex curved surface around the ear, which helps to fit the curved surface around the head, and effectively gives way to the ear contour at the same time. Therefore, the wearing comfort and stability of the whole structure are improved. In several embodiments, the second rods 120 can also include the design of turns in a lightning bolt style at the edge of the first buffer layer 100 (for example, the edge of the back of the head shown in the lower area of FIG. 1) to enhance friction against the head and improve the wearing stability.

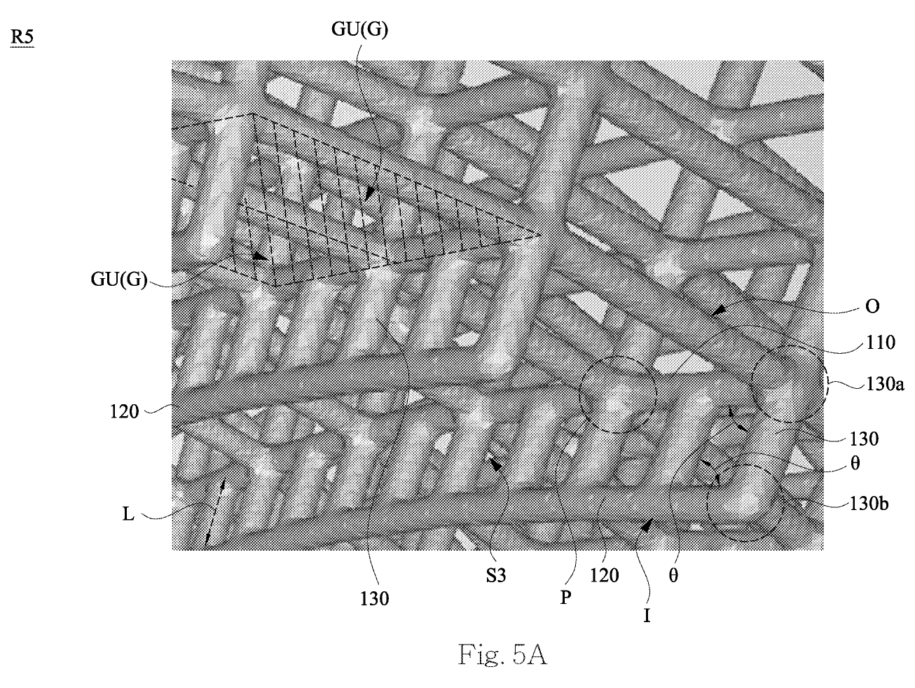

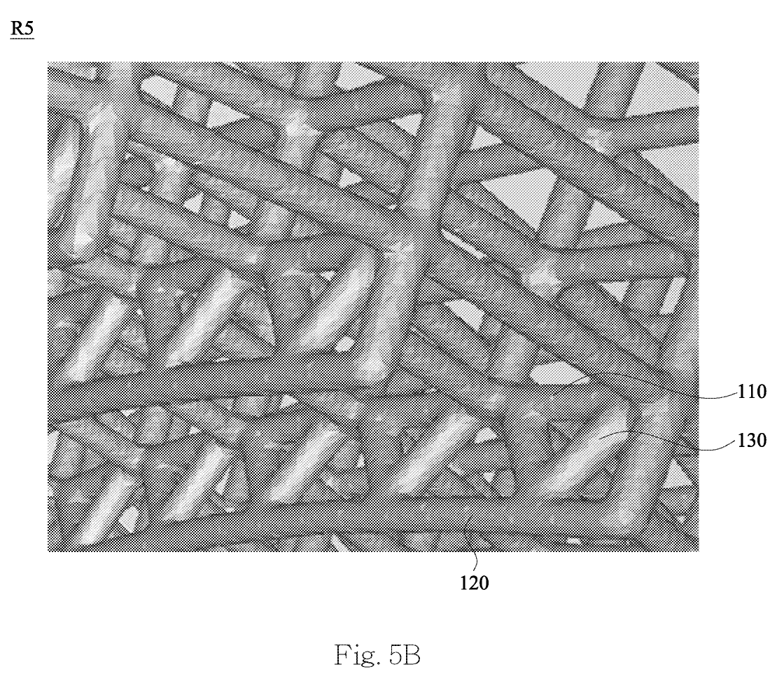

Please refer to FIG. 2 together with FIG. 5A. FIG. 5A is a partial enlarged schematic figure of an area R5 of the three-dimensional printed buffer structure 10 of FIG. 2. The supporting parts 130 are connected to the outer surface portion O and the inner surface portion I of the first buffer layer 100. More specifically, each supporting part 130 has a first end 130a and a second end 130b opposite to each other, in which the first end 130a and the second end 130b are respectively connected to any one of the first rods 110 and any one of the second rods 120. Since the supporting parts 130 firmly connect the first rods 110 and the second rods 120 together, when an external force is directed toward the helmet in a non-perpendicular direction (that is, a lateral direction), the structure may effectively restrict the relative displacement between the first rods 110 and the second rods 120 laterally. At the same time, through the friction between the second rods 120 and the head, the second rods 120 and the supporting parts 130 together can draw the first buffer layer 100 along with the helmet back to the original position, thus reducing the helmet lateral offset or rotation caused by the lateral force, and effectively reducing the relative movement between the helmet and the head of the user, enhancing wearing stability and enforcing the protection effect.

In addition, when the first buffer layer 100 is under external forces, the supporting parts 130 can be deflected by a small degree of relative displacement between the first rods 110 and the second rods 120. Such deflection force can redistribute the stress from an original single point to a wider area. More specifically, when an external force is applied to the first buffer layer 100 in a perpendicular direction to the force-receiving surface (for example, the outer surface portion O of the first buffer layer 100), the deflection effect caused by the supporting parts 130 can transform this vertical force into a horizontal force. This horizontal force can then further be dispersed to surrounding areas along the two-dimensional grid structure constituted by the first rods 110 and the continuously extending structure constituted by the second rods 120 (for example, dispersed along the contour of the outer surface portion O and the contour of the inner surface portion I of the first buffer layer 100), to further reduce damage caused by the stress that is concentrated locally toward a single point. Furthermore, the supporting parts 130 also have outstanding deflection recovery, and can temporarily store the energy therein under external forces and then release the energy quickly when the external forces are gone, generating a restoring force through the motion of bouncing back, thus pulling the second rods 120 back to the original position thereof.

In addition, the force that is perpendicular to the force-receiving surface is guided and dispersed to the first rods 110 and the second rods 120 through the plurality of supporting parts 130, and distributed to the surrounding areas along the extending directions of the first rods 110 and the second rods 120. Therefore, the amount of compression of the first buffer layer 100 in the perpendicular direction can be effectively reduced when under force, leading to an effective reduction in the whole structural deformation amount. Moreover, due to the reduction of the compression amount in the perpendicular direction, accumulated wear and fatigue in the first buffer layer 100 caused by the partial compression when under force can be effectively reduced, so that the support and buffering effects of the first buffer layer 100 remain stable.

In several embodiments, the supporting parts 130 mainly rely on the first rods 110 configured in the grid G as the base to support the second rods 120. Therefore, the plurality of supporting parts 130 are connected with the first rods 110 correspondingly according to the positions of the second rods 120 to form an interval structure type. More specifically, as shown in FIG. 5A, assuming that the extending direction of one second rod 120 is generally the same as the arrangement direction of one first rod 110 in the grid G, the supporting parts 130 can be arranged spaced apart from each other and connected to the corresponding first rods 110 at the intersection point P or the non-intersection point (for example, the rod section of the first rod 110).

In several embodiments, the supporting parts 130 can be in a straight column type. In other words, the supporting parts 130 do not include designs of bent or curved shapes. With the design of straight column types, the supporting parts 130 have a higher support capability (pressure resistance) that can effectively resist compression while under stress in the column axial direction to maintain stability of the structure, and adapt to deflection at various angles while under tilt stress (that is, stress not in the column axial direction) and disperse the stress to surrounding areas. In addition, the supporting parts 130 of the straight column type do not easily result in unexpected deformation under forces, and have relatively predictable and controllable mechanical responses, which reduce unstable movements or displacements when the helmet is under external forces. Therefore, relative displacements between the helmet and the head of the user are reduced, and the wearing safety of a helmet is improved.

In several embodiments, the connection angles θ between the supporting part 130 and the first rod 110, and between the supporting part 130 and the second rod 120 may respectively be in the range of 45 degrees to 135 degrees (for example, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees). It needs to be noted that the definition of the connection angle θ is specified as the connection angles θ between the supporting part 130 and the first rod 110, and between the supporting part 130 and the second rod 120, respectively, wherein these two supporting parts 130 are two separate items. When the connection angle θ is within the aforementioned range, the supporting part 130 can have both support and deflection effects that can disperse the stress while being used together with the first rods 110 and the second rods 120. Therefore, the whole structure has better deflection recovery and higher lateral rigidity to maintain stability of the structure, and prevent the situation of support deficiencies leading to no effective deflection when the connection angle θ is too small (less than 45 degrees, 10 degrees for example) or too large (larger than 135 degrees, 170 degrees for example).

In several embodiments, the first ends 130a of at least some supporting parts 130 need to be connected to the intersection points P of the grid G. In comparison with the non-intersection point of the grid G (that is, the rod section of the first rod 110), the intersection point P has higher structural strength and stability and may provide the supporting parts 130 with a more sufficient bearing capacity to effectively and directly distribute the stress to the whole grid system. In addition, connecting the supporting parts 130 to the intersection points P can also increase the connection strength between the supporting parts 130 and the grid G, thus further enhancing the capacity of deformation resistance of the whole structure. In the actual design, the connection positions of the plurality of supporting parts 130 and the grid G of the first buffer layer 100 can be adjusted or coordinated according to the usage scenarios and protection needs of the helmet, but the connection positions of the plurality of supporting parts 130 and the grid G of the first buffer layer 100 are not limited to only connecting to intersection point P or the non-intersection point.

The plurality of supporting parts 130 have hollowed-out areas S3, which are meant to allow the supporting parts 130 to be arranged spaced apart. In several embodiments, the hollowed-out areas S1 between the first rods 110 and the spacing areas S2 between the second rods 120 are interconnected to one another through the hollowed-out areas S3 between the supporting parts 130 (please refer to FIG. 2), to further form an air exchange cavity created by the outer surface portion O continuously extending to the inner surface portion I of the first buffer layer 100. In other words, the hollowed-out area S1, the spacing area S2, and the hollowed-out area S3 are interconnected and form an air exchange cavity. The continuously extended air exchange cavity may redistribute the air pressure created by external impact into the larger areas, thus helping to increase the buffering. Furthermore, the air exchange cavity may accelerate air circulation to prevent heat and moisture from accumulating within the helmet, and as a result, reduce the sultriness and keep the head of the user dry and comfortable.

In several embodiments, the length L of the supporting part 130 can be, for example, 3 cm to 10 cm (for example, 4 cm, 5 cm, 6 cm, 7 cm, 8 cm, 9 cm). The design within the aforementioned length range helps the supporting part 130 to reach a balance point between deflection and stress distribution uniformity. More specifically, if the supporting part 130 is too long, although the supporting part 130 can provide a larger scale in deflection while absorbing more energy, the supporting part 130 may become over-deformed, which reduces the deflection recovery capacity thereof. Furthermore, if the supporting part 130 is too long, it may lead to a longer distance for transferring the stress, preventing the stress from being dispersed uniformly to the first rods 110 and the second rods 120 effectively, resulting in the stress being distributed unevenly. If the supporting part 130 is too short, the deflection capacity will be limited and unable to fully absorb and disperse stress, resulting in the stress being concentrated in a single spot locally. In several embodiments, the length L of the supporting part 130 in the first buffer layer 100 can be designed depending on the area position of the helmet. For example, the supporting parts 130 in the same area can be designed with the same length L. In several embodiments, all the supporting parts 130 of the first buffer layer 100 of the helmet are designed with the same length L.

Please refer to FIG. 5B, which is a structural type of supporting parts 130 according to several other embodiments of the present disclosure, with the illustrated area corresponding to the area R5 of the three-dimensional printed buffer structure 10 of FIG. 2. In the embodiment shown in FIG. 5B, the two adjacent supporting parts 130 intersect one another at the second rod 120. In several other embodiments (not shown in the figure), the two adjacent supporting parts 130 also can intersect one another at the first rod 110. When the supporting parts 130 intersect one another at one position of the first rod 110 or the second rod 120, this position becomes the center of dispersing force in multiple directions that can distribute external forces more uniformly to all rod-shaped structures (for example, first rod 110, second rod 12, supporting parts 130) connected to this position, and reduce the chance of having concentrated stress locally. In several embodiments (not shown in the figure), the two adjacent supporting parts 130 may intersect one another to form a criss-cross structure in the space located between the first rod 110 and the second rod 120, allowing the supporting part 130 to gain one more intersection point, in addition to the intersections points at the first rod 110 and the second rod 120, which increases the routes for dispersing the stress. The criss-cross structures provide additional structural supports, which enhance the deformation resistance of the first buffer layer 100 in every direction.

Please refer to FIG. 2 again. In several embodiments, the entire first buffer layer 100 may be integrally formed by three-dimensional printing. In other words, the first rods 110, the second rods 120, and the supporting parts 130 of the first buffer layer 100 are integrally formed. An object integrally formed with seamless combination and material consistency may prevent possible weakness at seams and weakness of material interface, further improving the overall stress transfer efficiency, which allows the stress acting on the helmet to be distributed more uniformly over the entire first buffer layer 100 while preventing the stress from concentrating locally.

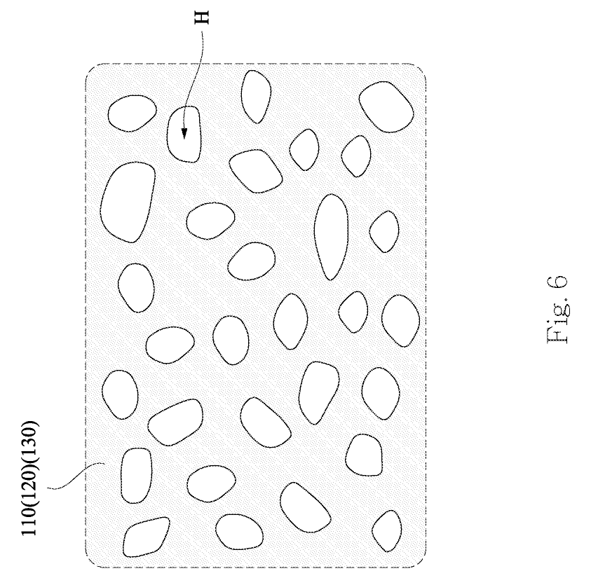

In several embodiments, the entire first buffer layer 100 can undergo a foaming process after being integrally formed by three-dimensional printing. In other words, each of the first rods 110, each of the second rods 120, and each of the supporting parts 130 of the first buffer layer 100 can have a plurality of foam structures, respectively. Please refer to FIG. 6, which is a schematic sectional micro-scale view of the first rod 110, the second rod 120, or the supporting part 130 according to several embodiments of the present disclosure, which illustrates foam structures H. The foam structures H can provide additional spaces to accommodate compression and deformation, which can effectively disperse and reduce impact by external forces, providing additional buffering and support effects. Furthermore, the foam structures H can allow the first buffer layer 100 to be made with reduced material usage under the premise of maintaining sufficient strength, thus achieving a balance between the goals of becoming lightweight and increasing strength. The foam structure H may increase air permeability and improve wearing comfort. In several embodiments, the foam structures H may be in micrometer (µm) scale, that is, the hole diameter of a single foam structure H may range from 10 µm to 800 µm (for example, 100 µm, 200 µm, 300 µm, 400 µm, 500 µm, 600 µm, 700 µm). In comparison with the foam structure H in nanometer scale, the foam structure H in micrometer scale is relatively less inclined to collapse or become deformed, and therefore the buffering and supporting effects thereof last longer. The foam structure H in micrometer scale can provide relatively higher air permeability and better wearing comfort.

In several embodiments, the materials for the first rod 110, the second rod 120, and the supporting part 130 of the first buffer layer 100 are the same. In several embodiments, the materials for the first rod 110, the second rod 120, and the supporting part 130 can be elastomers, including but not limited to thermoplastic polyurethane, polyurethane-based materials, polystyrene foams, and foams. Therefore the first buffer layer 100 has flexibility and formability that can more flexibly fit the head curve and prevent the suppression or discomfort on the head of the user caused by a rigid structure.

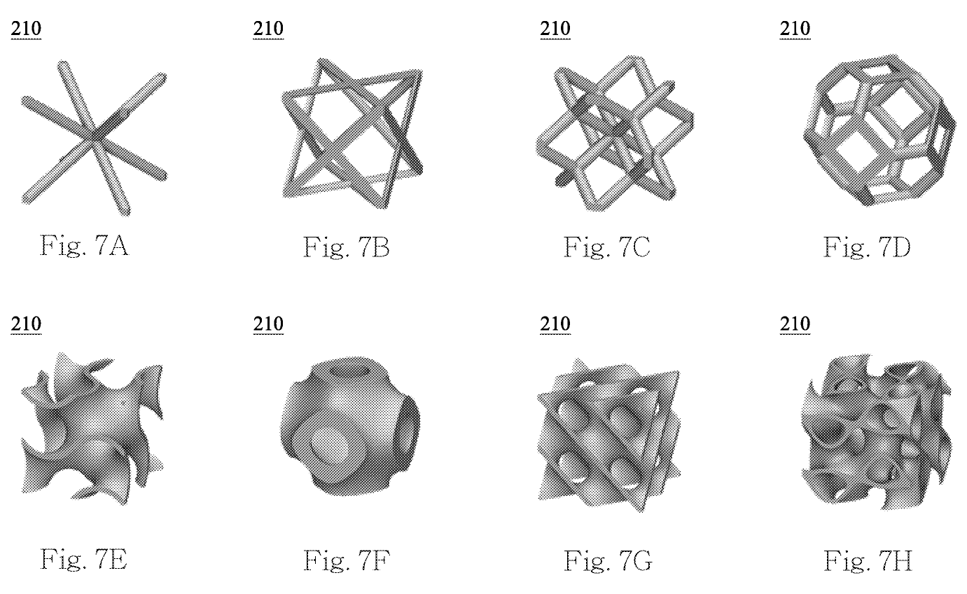

Please refer to FIG. 2 again. In several embodiments, the three-dimensional printed buffer structure 10 can further comprise a second buffer layer 200 disposed between the outer surface portion O of the first buffer layer 100 and the helmet shell. When the helmet is under the actions of external forces, the external forces may pass through the second buffer layer 200 and the first buffer layer 100 sequentially before reaching the head of the user. In several embodiments, the second buffer layer 200 may comprise a plurality of lattice structure units 210 disposed continuously in the three-dimensional space. In several embodiments, the lattice structure units 210 may be the continuation or stereoscopic extension in a three-dimensional space from the two-dimensional grid G. For example, the lattice structure unit 210 can be a cubical lattice structure in the three-dimensional space continuously extended from a quadrangular grid G shown in FIG. 2, and can be designed into multiple layers based on the requirement of whole buffering capacity. The second buffer layer 200 of the embodiment shown in FIG. 2 is presented as a three-layer design. In several other embodiments, the lattice structure of the lattice structure unit 210 can also be replaced by the lattice structures illustrated in FIGS. 7A to 7H, for example, the body-centered cubic lattice of FIG. 7A, the face-centered cubic lattice of FIG. 7B, the fluorite lattice of FIG. 7C, the Kelvin lattice of FIG. 7D, the gyroid lattice of FIG. 7E, the Schwarz lattice of FIG. 7F, the diamond lattice of FIG. 7G, and the split-P lattice of FIG. 7H. Overall, the second buffer layer 200 achieves the effects of directly absorbing the stress in a perpendicular direction to the force-receiving surface through a non-filled structural design, composed of the plurality of lattice structure units 210.

In several embodiments, the hollowed-out areas S4 of the lattice structure units 210 may be interconnected to the hollowed-out areas S1 between the first rods 110, and the spacing areas S2 between the second rods 120, and the hollowed-out areas S3 between the supporting parts 130, to further form an air exchange cavity created by the inner surface portion I of the first buffer layer 100 continuously extending to the outer surface portion U of the second buffer layer 200.

In several embodiments, the first buffer layer 100 and the second buffer layer 200 may be integrally formed by three-dimensional printing. In other words, the first rods 110, the second rods 120, and the supporting parts 130 of the first buffer layer 100, as well as the lattice structure units 210 of the second buffer layer 200, are integrally formed. In several other embodiments, the second buffer layer 200 may be combined with the first buffer layer 100 through appropriate methods, for example, gluing, mechanical assembly (for example, mortise and tenon, or clip and snap), welding (for example, thermal welding or ultrasonic welding), or installing additional securing parts, to provide flexibility in the design and assembly.

In several embodiments, the entire second buffer layer 200 can undergo a foaming process after being integrally formed by three-dimensional printing. In other words, each of the lattice structure units 210 of the second buffer layer 200 can have the plurality of foam structures H of the first buffer layer 100, as shown in FIG. 6.

It is worth mentioning that the design of the first buffer layer 100 of the present disclosure emphasizes the function of "reducing the lateral displacement or rotation of the helmet" delivered by the supporting parts 130. More specifically, the design can effectively restrict the relative displacement between the first rods 110 and the second rods 120 through the supporting parts 130, together with the friction between the second rods 120 and the head, to reduce the lateral displacement or rotation of the first buffer layer 100 caused by forces from the lateral direction. In addition, the supporting parts 130 can also achieve the function of "re-distributing the stress (dispersing the stress)," specifically through the deflection effect created by the supporting parts 130, which transforms the stress directed to the force-receiving surface vertically into a horizontal force. These horizontal forces are thus dispersed and further distributed to the nearby area through the two-dimensional structure of the first rods 110 and the continuously extending structure of the second rods 120, forcing the plurality of rod-shaped structures (for example, first rods 110, second rods 120) in the horizontal direction to share the vertical loads cooperatively, thus further reducing damage caused by the stress that is concentrated toward a single point locally. In several embodiments, the additionally disposed second buffer layer 200 can further provide the function of "absorbing the vertical stress," specifically through the geometric features (for example, the three-dimensional distribution of the lattice structure and the cavity design) and the material elasticity of the lattice structure units 210 directly absorbing the stress applied vertically to the force-receiving surface, to reduce the energy of the stress transferred to the inner layers. In other words, the first buffer layer 100 and the second buffer layer 200 achieve the buffering effect through different means. Overall, the first buffer layer 100 can achieve a fine protection performance through the functions of "reducing the lateral displacement or rotation of the helmet" and "redistributing the stress.” Nevertheless, by combining the first buffer layer 100 and the second buffer layer 200, the design may further enhance the effect of buffering and protection through the method of "absorbing the vertical stress," so that the whole protection performance of the helmet increases to provide even more comprehensive safety guard.

According to the aforementioned embodiments of the present disclosure, with the outer surface portion of the first buffer layer composed of grids (the first rods) of a non-filled design, the helmet can disperse the external force over a larger range that reduces the damage caused by concentrated stress to a single area, which effectively lowers the risk of injury. Through the inner surface portion of the first buffer layer, composed of rods (second rods) extending continuously and spaced apart and remaining adjacent to one another without intersecting, the helmet can provide a well-fitting (conformity) effect on the head and, with the design of the supporting parts, the helmet can also increase the friction between the first buffer layer and the head of the user in a specific direction to further limit the relative displacement between the helmet and the head of the user, thus restricting the helmet in lateral offset or rotation and increase the wearing stability of a helmet. Furthermore, through the deflection effect of the supporting parts, the first rods and the second rods in the horizontal direction share the load exerted vertically and achieve the stress-dispersion effect. Overall, through the synergy of the first rods, the second rods, and the supporting parts, the present disclosure can increase the whole protective performance and wearing stability of a helmet through a method different from those of “absorbing the vertical stress directly.”

The above preferred embodiments are presented to disclose the present disclosure and shall not be interpreted to limit the present disclosure in any way. Those skilled in the art may use any alternative embodiments that are modified or changed without departing from the spirit and scope of the present disclosure. Therefore, the protection scope of the present disclosure shall be determined by the attached scope of the claims.

### COMPONENT SYMBOL

10: Three-dimensional printed buffer structure

100: First buffer layer

110,110a,110b,110c,110d: First rod

120,120a,120b,120c: Second rod

130: Supporting part

130a: First end

130b: Second end

200: Second buffer layer

210: Lattice structure unit

Q: Arc-shaped curved surface

H: Foam structure

θ: Connection angle

L: Length

D: Distance

P: Intersection point

G: Grid

GU: Grid unit

O, U: Outer surface portion

I: Inner surface portion

S1, S3, S4: Hollowed-out area

S2: Spacing area

R1, R2, R3, R31, R32, R4, R41, R42, R5: Area

What is claimed is:

1. A three-dimensional printed buffer structure for helmets, comprising:
a first buffer layer comprising:
an outer surface portion, comprising a plurality of first rods, wherein the plurality of first rods is arranged to intersect and form a grid, with the plurality of first rods defining an outer contour near a helmet shell;
an inner surface portion, comprising a plurality of second rods, wherein the plurality of second rods extend continuously and are spaced apart, remaining adjacent to one another without intersecting, with the plurality of second rods defining an inner contour close to a user; and
a plurality of supporting parts, disposed between the outer surface portion and the inner surface portion, with each of the plurality of supporting parts having a first end and a second end, wherein the first end and the second end of any one of the plurality of supporting parts are respectively connected to any one of the plurality of first rods and any one of the plurality of second rods,
wherein, the plurality of first rods, the plurality of second rods, and the plurality of supporting parts are integrally formed by three-dimensional printing.

2. The three-dimensional printed buffer structure of claim 1, wherein any one of the plurality of supporting parts is a column.

3. The three-dimensional printed buffer structure of claim 2, wherein a first connection angle between any one of the plurality of supporting parts and the plurality of first rods that are connected thereto is 45 degrees to 135 degrees; and a second connection angle between any one of the plurality of supporting parts and the plurality of second rods that are connected thereto is 45 degrees to 135 degrees.

4. The three-dimensional printed buffer structure of claim 1, wherein the first end of any one of the plurality of supporting parts is connected to one intersection point of the grid.

5. The three-dimensional printed buffer structure of claim 1, wherein any two or more adjacent supporting parts of the plurality of supporting parts intersect with one another mutually.

6. The three-dimensional printed buffer structure of claim 5, wherein any two or more of the adjacent supporting parts intersect mutually with any one of the plurality of first rods or any one of the plurality of second rods.

7. The three-dimensional printed buffer structure of claim 1, further comprising:
a second buffer layer connected with the outer surface portion and disposed between the outer surface portion and the helmet shell, wherein the second buffer layer comprises a plurality of lattice structure units, and each of the plurality of lattice structure units has a hollowed-out area.

8. The three-dimensional printed buffer structure of claim 7, wherein the plurality of first rods, the plurality of second rods, the plurality of supporting parts, and the plurality of lattice structure units are integrally formed by three-dimensional printing.

9. The three-dimensional printed buffer structure of claim 1, wherein each of the plurality of first rods, each of the plurality of second rods, and each of the plurality of supporting parts has a plurality of foam structures respectively.

10. The three-dimensional printed buffer structure of claim 1, wherein the plurality of first rods have a plurality of first hollowed-out areas thereamong; the plurality of second rods have a plurality of second hollowed-out areas thereamong; the plurality of supporting parts have a plurality of third hollowed-out areas thereamong; and the plurality of first hollowed-out areas, the plurality of second hollowed-out areas, and the plurality of third hollowed-out areas are connected.
